(19) United States
(12) Patent Application Publication
(10) Pub. No.: US 2007/0272306 A1
(43) Pub. Date: Nov. 29, 2007

(54) Closure device with a pressure valve

(75) Inventors: Philippe Trotin, Quelaines (FR); Arnaud Champion, Laval (FR)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/802,550

(22) Filed: May 23, 2007

Related U.S. Application Data
(63) Continuation of application No. PCT/EP05/55887, filed on Nov. 10, 2005.

(30) Foreign Application Priority Data
Nov. 24, 2004 (FR) 0452739

(51) Int. Cl. F16K 15/00

(52) U.S. Cl. 137/455

(57) ABSTRACT

A closure device with a pressure valve in which the closure device is provided in the form of a protective cap (1) which has a groove (2) on its outer periphery. At least one discharge opening (3₁, 3₂) for a fluid is formed inside the groove and communicates with the interior of the vessel to be closed by the closure device. Both lateral arms (4₁, 4₂) of an elastically deformable clip (4) are forcibly inserted into the groove. At least one of these arms (4₁, 4₂) is provided with a seal (5₁, 5₂) which seals the fluid discharge opening (3₁, 3₂) in order to ensure a tight seal when the pressure difference between the interior of the vessel to be closed and the exterior environment is less than a first predetermined value, and which opens this opening when the pressure difference is greater than a second predetermined value.

### CROSS REFERENCE TO RELATED APPLICATIONS

This application is a continuation of international patent application no. PCT/EP2005/055887, filed Nov. 10, 2005 designating the United States of America and published in German on Jun. 1, 2006 as WO 2006/056537, the entire disclosure of which is incorporated herein by reference. Priority is claimed based on French patent application no. FR 0452739, filed Nov. 24, 2004.

### BACKGROUND OF THE INVENTION

The present invention relates to a closure device with a pressure valve.

A device of this type is used primarily to close an vessel located under the engine hood of an automobile, such as a coolant closure, an oil closure (e.g., of the cylinder head cover), the closure of the brake fluid reservoir or a backfire valve on the distributor.

For obvious safety reasons, various elements of automobiles must be provided with a closure device that is equipped with a pressure valve.

Devices of this type must satisfy a broad range of requirements. In particular, they must not show any signs of deterioration and must withstand a wide range of loading conditions that exist under the engine hood (temperature, hygrometry, thermal shocks, chemical aggression, etc.).

The conventional pressure valves used in this area have the disadvantage that they comprise several parts (an adjustment spring, a flap valve and a seal), which means that they are relatively expensive and also difficult to assemble and install.

### SUMMARY OF THE INVENTION

The object of the present invention is to obviate these drawbacks by providing a simpler and therefore cheaper closure device with a pressure valve, which can be installed without tools and which is moreover capable of operating within a temperature range of between −30 and +150° C.

According to the invention, a closure device of this type is characterized in that it is configured as a protective cap, along the outer circumference of which extends a substantially annular groove, which has, on the one hand, at least one fluid discharge opening drilled or otherwise formed into it, which communicates with the interior of the vessel to be closed, and, on the other hand, the two lateral arms of a U-shaped elastically deformable clip forcibly inserted into it on each side of the protective cap. A clip of this type may be formed of metal or a synthetic material.

According to the invention, at least one of the arms of this clip is lined with a seal or has a seal mounted to it. This seal closes the discharge opening for the fluid so as to ensure tightness when the pressure difference between the interior of the vessel to be closed and the exterior environment is less than a first predefined value or less than the sealing pressure, and it opens this opening when the pressure difference is greater than a second predefined value or greater than the triggering pressure, and thus forms the pressure valve.

It should be noted that when the pressure difference is less than the sealing pressure, the seal must ensure not only the tightness between the interior of the vessel to be closed and the external environment but also, and conversely, in relation to the fluid, which may come from the external environment (water under pressure, oil, etc.).

In one preferred embodiment of the invention, the groove is provided with two opposite discharge openings for a fluid, each of which has an adjoining seal.

According to this configuration, the two lateral arms of the elastically deformable clip spread in response to a pressure difference greater than the triggering pressure.

It should be noted that the groove is preferably provided with a projection that serves as a stop for the bight or central arm of the elastically deformable clip to make it easier to forcibly insert the clip into the groove.

In accordance with another preferred embodiment of the invention, the sealing pressure is preferably 150 mb.

According to yet another preferred embodiment of the invention, the triggering pressure preferably is 300 mb.

To ensure safety, the discharge opening for the fluid is preferably dimensioned so that 50 liters of fluid can flow out per minute when it is open.

### BRIEF DESCRIPTION OF THE DRAWINGS

The invention will be described in further detail hereinafter with reference to illustrative preferred embodiments shown in the accompanying drawing figures, in which:

FIG. 1 is a perspective view of the closure device in which the pressure valve is closed,

FIG. 2 is a perspective view similar to that shown in FIG. 1, but in which the pressure valve is open.

### DETAILED DESCRIPTION OF PREFERRED EMBODIMENTS

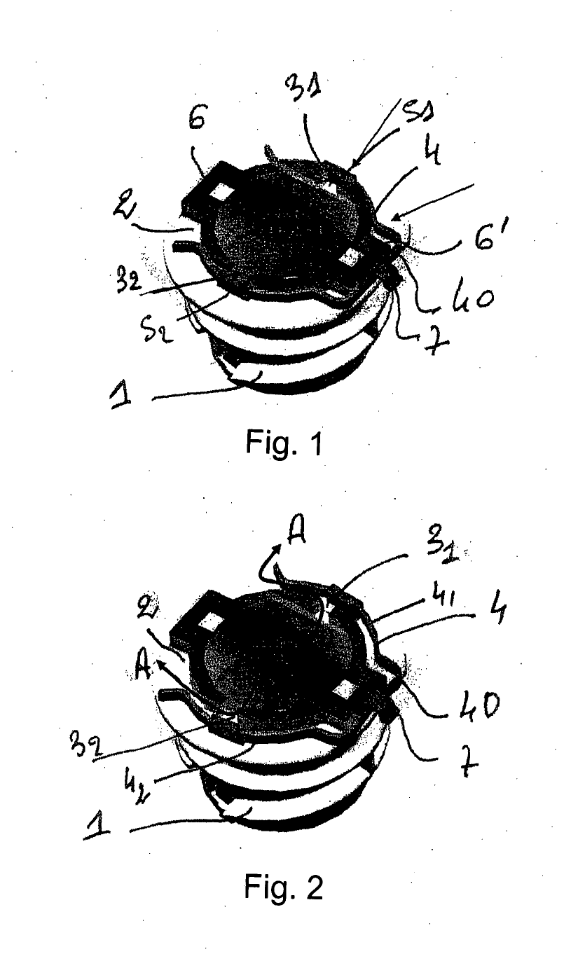

According to FIGS. 1 and 2, the closure device is configured as a protective cap 1, which in the example shown is provided with an external thread intended to cooperate with a corresponding internal thread in the vessel to be closed, which is not depicted in the drawings.

This protective cap 1 is provided with a substantially annular groove 2 along its outer circumference, into which are drilled two opposite outflow openings 3₁, 3₂ for a fluid and which establishes a connection between the interior of the vessel to be closed and the exterior environment.

The pressure valve is formed by an elastically deformable and substantially U-shaped clip 4, which comprises a central arm 40 and two lateral arms 4₁, 4₂.

According to FIGS. 1 and 2, the arms 4₁, 4₂ of the elastically deformable clip 4 have a geometry corresponding to that of the groove 2, and they are forcibly seated into this clip on each side of the protective cap 1, so that they enclose the protective cap in sandwich type fashion.

According to the configuration depicted in the figures, the groove 2 comprises two projections 6, 6′, one of which serves as a stop for the central arm 40 of the elastically deformable clip 4.

A hook 7 facilities the installation of this clip.

According to FIGS. 1 and 2, the lateral arms 4₁, 4₂ of the elastically deformable clip are furthermore each lined with a seal 5₁, 5₂ or a seal is placed onto them.

Each of these seals 5₁, 5₂ is associated with one of the two oppositely disposed fluid discharge openings 3₁, 3₂.

According to FIG. 1, when the pressure difference between the interior of the vessel to be closed and the exterior environment is less than a first predefined value, or when the sealing pressure is preferably 150 mb, the seals 5₁, 5₂ each close the associated fluid discharge openings 3₁, 3₂ to ensure a tight seal.

According to FIG. 2, when the pressure difference between the interior of the vessel to be closed and the exterior environment is greater than a second predefined value, or when the sealing pressure is preferably 300 mb, the two lateral arms 4₁, 4₂ of the elastically deformable clip 4 spread to ensure the discharge of fluid at a rate of preferably 150 liters per minute in the direction of arrow A and thereby to assure safety.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A closure device for closing a vessel, said closure device comprising a cap having a substantially annular groove on an outer circumference thereof and at least one fluid discharge opening formed in the annular groove, said discharge opening communicating with the interior of the vessel, said closure device further comprising a substantially U-shaped, elastically deformable clip having two lateral arms forcibly inserted in said groove on respective opposite sides of the cap, at least one of said arms having a seal which closes the discharge opening to ensure a tight seal when the pressure difference between the interior of the vessel and the exterior environment is less than a sealing pressure having a first predefined value, and which opens the discharge opening when the pressure difference between the interior of the vessel and the exterior environment is greater than a sealing pressure having a second predefined value, whereby said clip forms a pressure valve on the closure device.

2. A closure device as claimed in claim 1, wherein the groove is provided with two fluid discharge openings, said openings being disposed substantially opposite one another and each being provided with a seal.

3. A closure device as claimed in claim 1, wherein the sealing pressure is 150 mb.

4. A closure device as claimed in claim 1, wherein the triggering pressure is 300 mb.

5. A closure device as claimed in claim 1, wherein the groove is provided with a projection that forms a stop for the central arm of the elastically deformable U-shaped clip.

6. A closure device as claimed in claim 1, wherein said closure device is a cap for a liquid vessel in an engine compartment of a motor vehicle.

7. A closure device as claimed in claim 6, wherein said closure device is a coolant closure, an oil closure of a cylinder head cover, or a brake fluid reservoir closure.
